(19) United States
(12) Patent Application Publication
(10) Pub. No.: US 2012/0162798 A1
(43) Pub. Date: Jun. 28, 2012

(54) VEHICLE MIRROR CONTROL METHOD AND VEHICLE MIRROR CONTROL DEVICE

(75) Inventor: Noriyuki TAKEMASA, Yaizu-city (JP)

(73) Assignee: MURAKAMI CORPORATION, Shizuoka (JP)

(21) Appl. No.: 13/235,810

(22) Filed: Sep. 19, 2011

(30) Foreign Application Priority Data
Dec. 27, 2010 (JP) 2010-290483

(51) Int. Cl. B60R 1/02

(52) U.S. Cl. 359/843; 359/877

(57) ABSTRACT

When a mirror angle is automatically displaced toward a target position, if the movement is mechanically locked before reaching the target position, power supply to a motor can promptly be halt, and in the case of a low temperature and a low voltage where the operating speed is slow, the mirror angle can also reach the target position. If time during which no change in the mirror angle is detected after the start of power supply exceeds a long-term determination period, the power supply to the motor is halted.

The disclosure of Japanese Patent Application No. JP2010-290483 filed on Dec. 27, 2010 including the specification, drawings, claims and abstract is incorporated herein by reference in its entirety.

### BACKGROUND OF THE INVENTION

1. Field of the Invention

The present invention relates to a vehicle mirror control method and device for controlling a motor for electrically displacing a mirror angle of a vehicle mirror, which are arranged so that when the mirror angle is automatically displaced toward a target position (target angle), if the movement is mechanically locked before reaching the target position, power supply to the motor can promptly be halted and even in the case of a low temperature and a low voltage where the operating speed is slow, the vehicle mirror can reach the target position.

2. Description of the Related Art

As a vehicle mirror whose mirror angle is electrically adjusted (hereinafter referred to as “electric mirror”), there is one arranged to set a mirror angle or a mirror angle displacement amount and automatically displace the mirror angle toward the corresponding target position. For example, in the case of an electric mirror called “memory mirror”, a mirror angle (including a vertical angle and a horizontal angle) manually adjusted by a driver is detected and stored in a memory, and when returning the mirror angle to its original mirror angle after being changed to another angle, the mirror angle stored in the memory is read and set as a target value via a one-touch operation of, e.g., a switch to automatically adjust the mirror angle to the read target value (memory operation). Meanwhile, in the case of an electric mirror called “reverse interlock mirror”, a mirror surface of a vehicle outer mirror is rotated downward by the amount of a predetermined angle in relation to gearshift operation means of the vehicle being put into a reverse position so that a driver can view an area around the rear wheel when driving the vehicle back (e.g., making the vehicle enter a parking space), and subsequently, the mirror surface is rotated upward by the amount of the predetermined angle to return to its original mirror angle in relation to the gear shift operation means being switched from the reverse position to another gear position (reverse interlock operation). An example of the memory mirror is disclosed in Japanese Patent Laid-Open No. S59-156842. An example of the reverse interlock mirror is disclosed in Japanese Patent Laid-Open No. H01-314640.

FIG. 2 illustrates a general adjustment range in which a mirror angle of an electric mirror can be adjusted. A semi-spherical projection portion at a center portion of a back surface of a mirror body of an electric mirror (the mirror body is prepared by fitting a mirror plate into a mirror holder, thereby mounting the mirror plate on the mirror holder) is slidably housed and held by a semi-spherical recess portion formed at a front surface of a plate pivot of a mirror angle actuator in a mirror housing, and the mirror body is thereby supported by the mirror angle actuator. Consequently, a mirror angle of the mirror body can be adjusted vertically and horizontally relative to the plate pivot within a range beyond which the mirror body is mechanically locked. The vertical and horizontal mirror angle adjustments are made by individual motors (a vertical adjustment motor and a horizontal adjustment motor). A mirror angle of an electric mirror can be adjusted within a maximum range of ±θ° from a center position of the adjustment range (at which the vertical and horizontal angles are both 0°) for each of the vertical and horizontal directions. However, vertical adjustment to the maximum of ±θ° is possible when the horizontal angle is 0°: as the horizontal angle is shifted farther from 0°, the vertical adjustment range is narrower. Similarly, horizontal adjustment to the maximum of ±θ° is possible when the vertical angle is 0°: as the vertical angle is shifted farther from 0°, the horizontal adjustment range is narrower. Consequently, the mirror angle can be adjusted within the range indicated by the circle in FIG. 2.

A case where a reverse interlock operation is performed when a mirror angle can be adjusted within the adjustment range illustrated in FIG. 2 will be considered. A reverse interlock operation is performed by displacing a vertical mirror angle downward by a predetermined angle amount Δθ from the then-current mirror angle with a horizontal mirror angle remained unchanged when gearshift operation means being put into a reverse position. Now, it is assumed that a reverse interlock operation is started when a horizontal mirror angle is positioned at A1, which is closer to the center of the adjustment range in FIG. 2. In this case, power supply to a motor is halted when it is detected that the mirror angle reaches a position A2 as a result of being rotated downward by the set amount Δθ. Meanwhile, it is assumed that a reverse interlock operation is started when the horizontal mirror angle is positioned at B1, which is away from the center of the adjustment range. In this case, a position B2 that the mirror angle would reach as a result from being rotated downward by the set amount Δθ falls out of the adjustment range, and thus, the mirror angle cannot actually reach the position B2 and is mechanically locked at a position B2′ on an outer edge of the adjustment range, which falls short of the position B2. However, the control device for the motor continues power supply to the motor so as to change the mirror angle to reach the target position B2. Consequently, a clutch arranged between the mirror angle actuator and the mirror body is periodically disengaged (slipped), generating unpleasant clicky sound. For a conventional countermeasure for this problem, for example, the difference between a target position and a current position (a current angle) detected by a position sensor (an angle sensor) is monitored, and power supply to the motor is halted if the difference is not decreased beyond a predetermined dead zone continuously for a predetermined time period.

A cause of the case where the difference between a target position and a current position is not decreased in a reverse interlock operation or a memory operation may be a failure of the motor, an abnormality of the position sensor or slippage for any cause. In addition, a motion start delay in the case of a low temperature and a low voltage (for example, a case where the voltage of a 12V battery is lowered to 8V at a temperature of −30° C.) can also be considered as a cause. In other words, as illustrated in FIG. 3, in a reverse interlock operation or a memory operation in the case of an ordinary temperature and/or an ordinary voltage, as indicated by a characteristic a, a speed of displacement of the mirror angle is not extremely slow, the difference between a target position and a current position is decreased beyond a predetermined dead zone within a set time period T from a start of power supply, and a state in which the difference is not decreased beyond a dead zone does not occur continuously for the set time period T until the mirror angle reaches the target position. Thus, the power supply to the motor is continued and then halted when the mirror angle reaches the target position. Meanwhile, in the case of a low temperature, a viscosity of a grease charged in the actuator increases, resulting in an increased load imposed on the actuator, and furthermore, in the case of a low battery voltage, a torque for driving the motor is lowered. Accordingly, in the case of a low temperature and a low voltage, as indicated by a characteristic b, the speed of displacement of the mirror angle is extremely slow. Therefore, the difference between the target position and the current position is not decreased beyond the predetermined dead zone within the set time period T from the start of the power supply, and after a lapse of the set time period T, the power supply to the motor is halted. Therefore, even in the case where the mirror angle should be able to be moved to the target position (for example, the case where the mirror angle is moved from the position A1 to the position A2 in FIG. 2), the movement of the mirror angle is stopped somewhere on the way before reaching the target position. In order to prevent such failure, if the set time period T is made to be longer, when the displacement is mechanically locked (for example, mechanically locked at the position B2′ in FIG. 2) before the mirror angle reaching the target position in the case of an ordinary temperature and an ordinary voltage, slippage of the clutch continues for a long period of time until the end of a set time period T (another set time period T starts because the difference between the target position and the current position comes not to decrease immediately after the locking).

The present invention aims to provide a vehicle mirror control method and a vehicle mirror control device, which solve the aforementioned conventional art problems, and are arranged to when automatically displacing a mirror angle toward a target position, promptly halt power supply to a motor when the movement is mechanically locked before the mirror angle reaching the target position, and make the mirror angle reach the target position even in the case of a low temperature and a low voltage where the operating speed is slow.

### SUMMARY OF THE INVENTION

The present invention provides a vehicle mirror control method for controlling a motor to displace a mirror angle of a vehicle mirror toward a target position while detecting a current position of the mirror angle, the method including: a first time period setting step of setting a first time period as a reference value for monitoring time during which a state where no change in the mirror angle is detected continues from a start of power supply to the motor to displace the mirror angle toward the target position; a second time period setting step of setting a second time period as a reference value for monitoring time during which a state where no decrease in a difference between the target position and the current position is detected continues during the power supply to the motor to displace the mirror angle toward the target position, the second time period being shorter than the first time period; a first halting step of when the time during which a state where no change in the mirror angle is detected continues from a start of power supply to the motor to displace the mirror angle toward the target position exceeds the first time period, halting the power supply to the motor; a second halting step of when a change in the mirror angle is detected before a lapse of the first time period after the start of the power supply to the motor to displace the mirror angle to the target position, continuing the power supply to the motor, and subsequently, when the time during which a state where no decrease in the difference between the target position and the current position is detected continues exceeds the second time period, halting the power supply to the motor; and a third halting step of when none of the first halting step and the second halting step halts the power supply to the motor before the mirror angle reaching the target position, halting the power supply to the motor so as to halt the mirror angle at the target position.

The present invention provides a vehicle mirror control device for controlling a motor to displace a mirror angle of a vehicle mirror toward a target position while detecting a current position of the mirror angle, the control device including: a mirror angle detection unit that detects the mirror angle; a first time period setting unit that sets a first time period as a reference value for monitoring time during which a state where no change in the mirror angle is detected continues from a start of power supply to the motor to displace the mirror angle toward the target position; a second time period setting unit that sets a second time period as a reference value for monitoring time during which a state where no decrease in a difference between the target position and the current position is detected continues during the power supply to the motor to displace the mirror angle toward the target position, the second time period being shorter than the first time period; and a control unit that controls the power supply to the motor to displace the mirror angle toward the target position, wherein the control performed by the control unit includes: first halting control for when the time during which a state where no change in the mirror angle is detected continues from a start of power supply to the motor to displace the mirror angle toward the target position exceeds the first time period, halting the power supply to the motor; second halting control for when a change in the mirror angle is detected before a lapse of the first time period after the start of the power supply to the motor to displace the mirror angle to the target position, continuing the power supply to the motor, and subsequently, when the time during which a state where no decrease in the difference between the target position and the current position is detected continues exceeds the second time period, halting the power supply to the motor; and third halting control for when none of the first halting control and the second halting control halts the power supply to the motor before the mirror angle reaching the target position, halting the power supply to the motor so as to halt the mirror angle at the target position.

As described above, a mirror angle adjustment motor may not start rotating immediately after power supply in the case of a low temperature and a low voltage. However, even in such case, the motor gradually starts rotating, and once the motor starts rotating, the motor continues the rotation unless the power supply is discontinued. Accordingly, setting a first time period to a time period sufficient to detect a change in the mirror angle even at a low temperature and a low voltage can prevent the mirror angle from stopping somewhere on the way without reaching the target position and make the mirror angle reach the target position in the case of a low temperature and a low voltage. If a change is detected before a lapse of the first time period, the set time period is switched from the first time period to a second time period that is shorter than the first time period, and time during which a state where no decrease in the difference between the target position and the current position is detected continues is monitored using the second time period. Consequently, upon occurrence of slippage in the clutch, the power supply to the motor can promptly be halted. Furthermore, where no change in the mirror angle is detected because of a failure or an abnormality of, e.g., the motor or a position sensor, the power supply to the motor is halted after a lapse of the first time period, and thus, the motor can be prevented from being continuously driven.

In the present invention, in the first halting control (the first halting step), a change in the mirror angle can be detected when the change in the mirror angle exceeds a predetermined dead zone, and in the second halting control (the second halting step), a decrease in the difference between the target position and the current position can be detected when the difference between the target position and the current position is decreased beyond a predetermined dead zone. Consequently, a false operation due to noise in position detection can be prevented. Furthermore, the time during which a state where no decrease in the difference between the target position and the current position is detected continues can be measured as, for example, time during which a state where a minimum value of the difference between the target position and the current position is not updated continues.

### BRIEF DESCRIPTION OF THE DRAWINGS

FIG. 1 is a function block diagram illustrating an embodiment of a vehicle mirror control device according to the present invention;

FIG. 2 is a diagram illustrating a general adjustment range in which a mirror angle of an electric mirror can be adjusted;

FIG. 3 is a graph indicating temporal change in a vertical mirror angle in a reverse interlock operation or a memory operation;

FIG. 4 is a graph indicating temporal change in a mirror angle when slippage occurs in a clutch; and

FIG. 5 is a flowchart illustrating an example of content of control performed by a control unit 20 in FIG. 1.

### DETAILED DESCRIPTION OF THE PREFERRED EMBODIMENTS

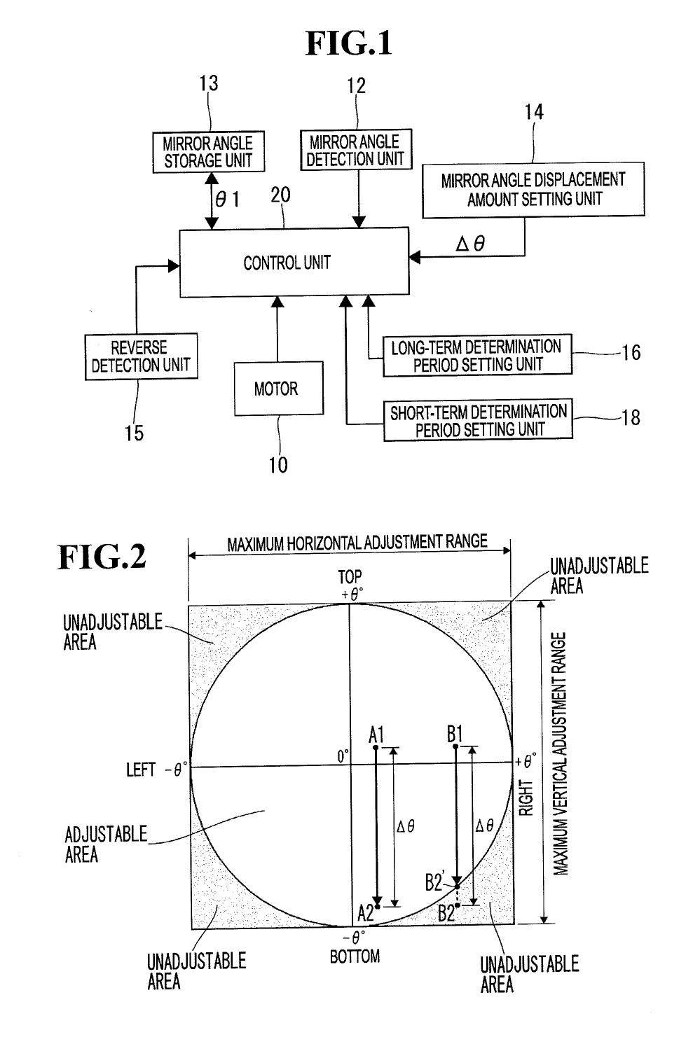

An embodiment of the present invention will be described below. Here, a case where the present invention is applied to reverse interlock control will be described. FIG. 1 is a function block diagram illustrating an embodiment of a vehicle mirror control device according to the present invention. Here, only a part related to reverse interlock control is illustrated. A motor 10 is a motor that vertically displaces a mirror angle. A mirror angle detection unit 12 detects a current value of a vertical mirror angle. For mirror angle detection, for example, a variable resistor (such as described in, e.g., Japanese Patent Laid-Open No. 2006-96131), a pressure sensor (such as described in, e.g., Japanese Patent Laid-Open No. 2006-96147) or a combination of permanent magnets and a hall element (such as described in, e.g., Japanese Patent Laid-Open No. 2007-198989) may be used. A mirror angle storage unit 13 stores a vertical mirror angle θ1 immediately before the start of a reverse interlock control, which is to be detected by the mirror angle detection unit 12 at the start of the reverse interlock operation, until the end of the reverse interlock operation (until the mirror angle is returned to its original position). A mirror angle displacement amount setting unit 14 sets a target value (Δθ in FIG. 2) of a change amount of the mirror angle in the reverse interlock operation. A target position of the mirror angle in the reverse interlock control can be provided by θ1+Δθ. A reverse detection unit 15 detects putting gearshift operation means of the vehicle into a reverse position as well as releasing the gearshift operation means from the reverse position (switching the gearshift operation means into another gear position).

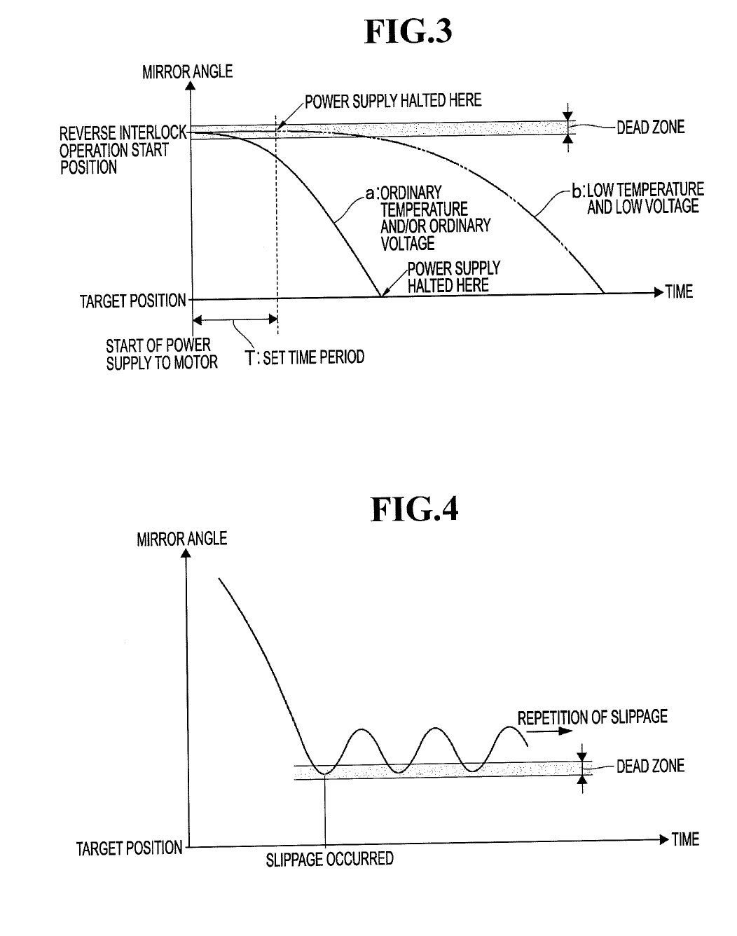

A long-term determination period setting unit (first time period setting unit) 16 sets a long-term determination period (first time period) as a reference value for monitoring time during which a state where no change in the mirror angle is detected continues from the start of power supply to the motor 10 to displace the mirror angle toward the target position by means of reverse interlock control. The long-term determination period is a time period sufficient to detect a change in the mirror angle beyond a dead zone (FIG. 3) even in the case where, for example, the voltage of a 12V battery is lowered to 8V at a temperature of −30° C., and for example, may be set to ten seconds. Accordingly, even at a low temperature and a low voltage, a displacement of the mirror angle can be detected within the long-term determination period. Furthermore, even if slippage has occurred in a clutch from the beginning of power supply to the motor 10, the mirror angle is repeatedly displaced within a certain angle range (see FIG. 4), and thus, a change in the mirror angle can be detected. Therefore, if no displacement of the mirror angle is detected within the long-term determination period, it can be determined that there is any failure or abnormality (e.g., the motor 10 suffers a failure, resulting in an actuator not operating, or a detection signal not being output from the mirror angle detection unit 12), and thus, the power supply to the motor 10 may be halted immediately after a lapse of the long-term determination period.

A short-term determination period setting unit (second time period setting unit) 18 sets a short-term determination period (second time period) as a reference value for monitoring time during which a state where no decrease in a difference between the target position and the current position is detected continues after a change in the mirror angle in the long-term determination period has been detected. Upon occurrence of slippage, as illustrated in FIG. 4, the mirror angle is repeatedly displaced within a certain angle range, and a state where the difference between the target position and the current position is not decreased continues, and thus, slippage can be detected by measuring time during which the state of the difference being not decreased continues. The short-term determination period is set as time for determining that slippage occurs in the clutch, and is set to, for example, one second. Even at a low temperature and a low voltage, once a movement to displace the mirror angle is started (that is, after a displacement of the mirror surface has been detected in the long-term determination), the mirror angle is continuously displaced toward the target position unless the movement is mechanically locked, and thus, in the short-term determination, the state of the difference between the target position and the current position being not decreased does not continue longer than the short-term determination period. Accordingly, if the state of the difference between the target position and the current position being not decreased continues for the short-term determination period in the short-term determination, it can be determined that slippage has occurred in the clutch, and thus, the power supply to the motor 10 may be halted immediately after a lapse of the short-term determination period. Meanwhile, if the state of the difference between the target position and the current position being not decreased does not continue for the short-term determination period in the short-term determination, it can be determined that there is no abnormality, and thus, the power supply to the motor 10 may be continued and then halted when the mirror angle reaches the target position.

A control unit 20 performs the following control as control for starting a reverse interlock operation, and thus, displacing the mirror angle toward the target position when the gearshift operation means of the vehicle is put into the reverse position.

Long-term determination is performed when the power supply to the motor 10 to displace the mirror angle to the target position is started. That is, time during which no change in the mirror angle is detected is measured, and when such time exceeds the long-term determination period, the power supply to the motor 10 is halted.

If a change in the mirror angle is detected before a lapse of the long-term determination period after the start of the power supply to the motor 10, the short-term determination is performed in place of the long-term determination. That is, the power supply to the motor 10 continues and time during which a state where no decrease in the difference between the target position and the current position is detected continues is measured, and if such time exceeds the short-term determination period, the power supply to the motor 10 is halted.

If none of the long-term determination and the short-term determination halts the power supply to the motor 10 and the mirror angle reaches the target position, the power supply to the motor 10 is halted at the target position.

As a result of controlling the motor 10 as described above, the following operations are performed.

(a) If, e.g., a failure of the motor 10 or an abnormality of the mirror angle detection unit 12 has occurred from the beginning of the reverse interlock control, the power supply to the motor 10 is halted after a lapse of the long-term determination period.
(b) If slippage occurs in the clutch as a result of the displacement of the mirror angle being mechanically locked before the mirror angle reaching the target position, the power supply to the motor 10 is halted after a lapse of the short-term determination period.
(c) Even at a low temperature and a low voltage, the mirror angle reaches the target position as in the case of a non-low temperature and/or a non-low voltage unless a failure of the motor 10, an abnormality of the mirror angle detection unit 12 or slippage in the clutch Occurs.

Accordingly, if the movement is mechanically locked before the mirror angle reaching the target position, the power supply to the motor 10 can promptly be halted, and even in the case of a low temperature and a low voltage where the operating speed is slow, it can be ensured that the mirror angle reaches the target position, and furthermore, upon occurrence of, e.g., a failure of the motor 10 or an abnormality of the mirror angle detection unit 12, the power supply can also be halted.

When the gearshift operation means is switched from the reverse position into another gear position, the control unit 20 performs control to drive the motor 10 in the opposite direction to return the mirror angle to the position θ1 of the mirror angle immediately before the start of the reverse interlock control, which is stored in the mirror angle storage unit 13.

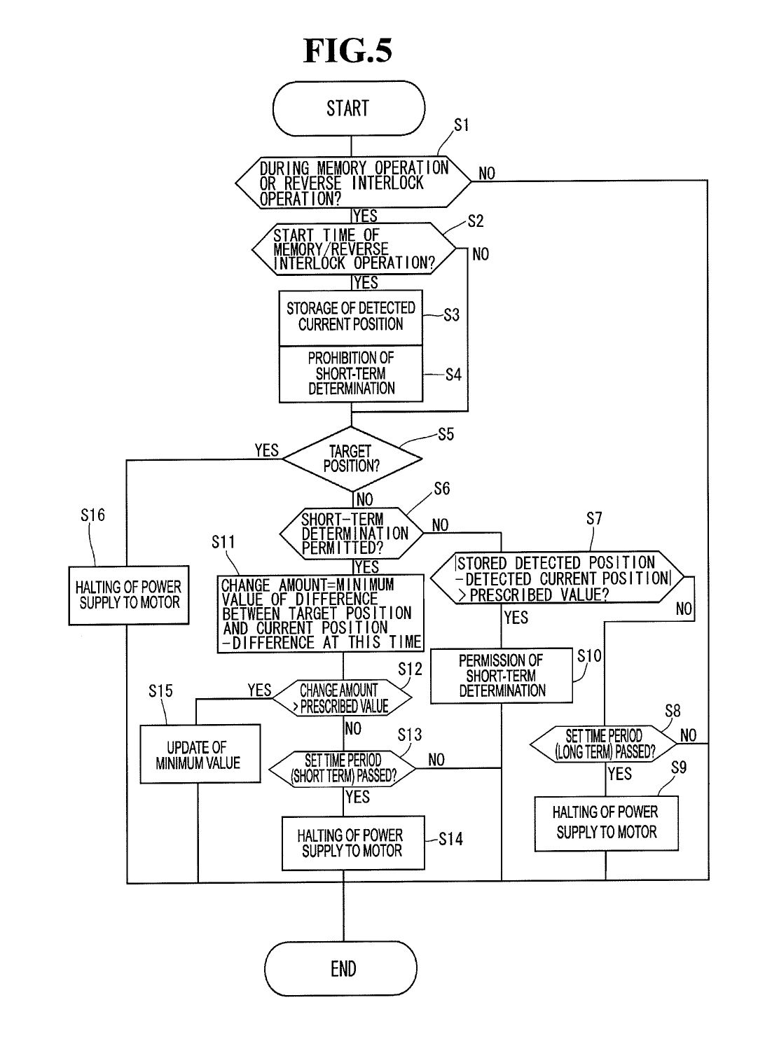

FIG. 5 is a flowchart illustrating an example of the control performed by the control unit 20. The routine of the entire flowchart is repeated, e.g., every five milliseconds. The reverse interlock control will be described with reference to FIG. 5. When the gearshift operation, means of the vehicle is put into the reverse position, which is then detected by the reverse detection unit 15, power supply to the motor 10 is started to displace the mirror angle toward a target position, and long-term determination is started. Concurrently, the control in FIG. 5 is started. That is, it is during a reverse interlock control (“YES” in S1) and it is the start time of the reverse interlock operation (“YES” in S2), and thus, a current value of the mirror angle detected by the mirror angle detection unit 12 is stored in the mirror angle storage unit 13 (S3), short-term determination is prohibited (“NO” in S5 and S6 via S4), and the long-term determination is continued (“NO” in S7 and S8). In the long-term determination, whether or not a displacement of the mirror angle is detected within a set long-term determination period (for example, ten seconds) from the start of the long-term determination is determined. If, e.g., the motor 10 or the mirror angle detection unit 12 has a failure or an abnormality and time during which a state of no displacement exceeding a certain prescribed value (dead zone in FIG. 3) of the mirror angle being detected (“NO” in S7) due to such failure or abnormality even though the reverse interlock operation is started continues exceeds the long-term determination period (“YES” in S8), the power supply to the motor 10 is halted (S9). The time during which the state of no displacement of the mirror angle being detected continues can be measured in terms of the number of times the determination of “NO” is successively made in step S7. That is, supposing that the flow in FIG. 5 is repeated every five milliseconds, the power supply to the motor 10 is halted when, for example, determination of “NO” is successively made in step S7 two thousand times (5 msec×2000 times=10 seconds) (S9). Consequently, it is possible to prevent the power supply to the motor 10 from continuing when, e.g., the motor 10 has a failure, hindering a movement to displace the mirror angle or a position sensor has an abnormality, disabling detection of a change in the mirror angle.

Upon a change exceeding the prescribed value being detected in the long-term determination period after the start of the reverse interlock operation (“YES” in S7), the long-term determination is ended and the control transitions to short-term determination (S10). In the short-term determination, time during which a state of a difference between the target position and the current position being not decreased beyond the prescribed value (dead zone in FIG. 4) continues is measured, and whether or not the continuance time exceeds a short-term determination period (for example, one second) is determined. That is, in the short-term determination, the following operation is performed.

(1) A difference between the target position and the current position is obtained and stored.
(2) A difference between the stored difference and a difference obtained later (amount of change in the difference between the target position and the current position) is obtained (S11).
(3) If the amount of change exceeds the prescribed value (dead zone in FIG. 4) (the difference between the target position and the current position is decreased) (“YES” in S12), the stored difference is updated with the later obtained difference (S15).
(4) If the amount of change does not exceed the prescribed value (the difference between the target position and the current position is not decreased) (“NO” in S12), the stored difference is not updated.
(5) The above-described operation is repeated for every repetition period of the flow in FIG. 5 (for example, 5 milliseconds), and as a result, the minimum value of the difference between the target position and the current position is sequentially updated and stored.
(6) Time during which a state of the amount of change not exceeding the prescribed value continues is measured in terms of the number of times determination of “NO” is successively made in step S12 (that is, the number of times where the minimum value is successively not updated) is measured (S13), and when such time exceeds the short-term determination period (for example 5 msec×200 times=1 second) (“YES” in S13), the power supply to the motor 10 is halted (S14). Consequently, upon occurrence of slippage in the clutch, the motor 10 can be stopped in a short time to prevent the slippage from continuing for a long time.

If after detection of a displacement in the long-term determination, approach of the mirror angle to the target position is detected in the short-term determination (“YES” in S12), the power supply to the motor 10 to displace the mirror angle toward the target position is continued, and if the mirror angle reaches the target position (“YES” in S5), the power supply to the motor 10 is halted (S16). Consequently, a driver can drive his/her vehicle back while viewing an area around the rear wheel through the mirror. When the gearshift operation means of the vehicle is returned from the reverse position to another gear position, the mirror angle is returned to its original position stored in step S3.

Although in the above embodiment, the dead zones (FIGS. 3 and 4) are set in the long-term determination and the short-term determination, respectively, determination can be made without setting a dead zone in each of the long-term determination and the short-term determination. Although in the above embodiment, the mirror angle θ1 immediately before the start of the reverse interlock control+the mirror angle change amount setting value Δθ is determined as a target value of the mirror angle in a reverse interlock operation, a target value according to the present invention is not limited to this and a fixed mirror angle can also be determined as a target value of the mirror angle in a reverse interlock operation. Furthermore, although the above embodiment has been described in terms of a case where the present invention is applied to reverse interlock control, the present invention can be applied to memory mirror control in which a mirror angle is displaced to a target position stored in advance. The memory mirror control is performed by storing a mirror angle at a target position in the mirror angle storage unit 13 in FIG. 1 for each of a vertical adjustment motor and a horizontal adjustment motor (the mirror angle displacement amount setting unit 14 is not needed), and reading the target position via a reading operation performed by a driver to perform the control in FIG. 5.

What is claimed is:

1. A vehicle mirror control method for controlling a motor to displace a mirror angle of a vehicle mirror toward a target position while detecting a current position of the mirror angle, the method comprising:
a first time period setting step of setting a first time period as a reference value for monitoring time during which a state where no change in the mirror angle is detected continues from a start of power supply to the motor to displace the mirror angle toward the target position;
a second time period setting step of setting a second time period as a reference value for monitoring time during which a state where no decrease in a difference between the target position and the current position is detected continues during the power supply to the motor to displace the mirror angle toward the target position, the second time period being shorter than the first time period;
a first halting step of when the time during which a state where no change in the mirror angle is detected continues from a start of power supply to the motor to displace the mirror angle toward the target position exceeds the first time period, halting the power supply to the motor;
a second halting step of when a change in the mirror angle is detected before a lapse of the first time period after the start of the power supply to the motor to displace the mirror angle to the target position, continuing the power supply to the motor, and subsequently, when the time during which a state where no decrease in the difference between the target position and the current position is detected continues exceeds the second time period, halting the power supply to the motor; and
a third halting step of when none of the first halting step and the second halting step halts the power supply to the motor before the mirror angle reaching the target position, halting the power supply to the motor so as to halt the mirror angle at the target position.

2. A vehicle mirror control device for controlling a motor to displace a mirror angle of a vehicle mirror toward a target position while detecting a current position of the mirror angle, the control device comprising:
a mirror angle detection unit that detects the mirror angle;
a first time period setting unit that sets a first time period as a reference value for monitoring time during which a state where no change in the mirror angle is detected continues from a start of power supply to the motor to displace the mirror angle toward the target position;
a second time period setting unit that sets a second time period as a reference value for monitoring time during which a state where no decrease in a difference between the target position and the current position is detected continues during the power supply to the motor to displace the mirror angle toward the target position, the second time period being shorter than the first time period; and
a control unit that controls the power supply to the motor to displace the mirror angle toward the target position,
wherein the control performed by the control unit includes:
first halting control for when the time during which a state where no change in the mirror angle is detected continues from a start of power supply to the motor to displace the mirror angle toward the target position exceeds the first time period, halting the power supply to the motor;
second halting control for when a change in the mirror angle is detected before a lapse of the first time period after the start of the power supply to the motor to displace the mirror angle to the target position, continuing the power supply to the motor, and subsequently, when the time during which a state where no decrease in the difference between the target position and the current position is detected continues exceeds the second time period, halting the power supply to the motor; and
third halting control for when none of the first halting control and the second halting control halts the power supply to the motor before the mirror angle reaching the target position, halting the power supply to the motor so as to halt the mirror angle at the target position.

3. The vehicle mirror control device according to claim 2,
wherein in the first halting control, a change in the mirror angle is detected when the change in the mirror angle exceeds a predetermined dead zone; and
wherein in the second halting control, a decrease in the difference between the target position and the current position is detected when the difference between the target position and the current position is decreased beyond a predetermined dead zone.

4. The vehicle mirror control device according to claim 2, wherein the time during which a state where no decrease in the difference between the target position and the current position is detected continues is time during which a state where a minimum value of the difference between the target position and the current position is not updated continues.

5. The vehicle mirror control device according to claim 3, wherein the time during which a state where no decrease in the difference between the target position and the current position is detected continues is time during which a state where a minimum value of the difference between the target position and the current position is not updated continues.

6. The vehicle mirror control device according to claim 2, wherein the target position is a target position of the mirror angle when the mirror angle is displaced downward in relation to gearshift operation means of the vehicle being put into a reverse position.

7. The vehicle mirror control device according to claim 3, wherein the target position is a target position of the mirror angle when the mirror angle is displaced downward in relation to gearshift operation means of the vehicle being put into a reverse position.

8. The vehicle mirror control device according to claim 4, wherein the target position is a target position of the mirror angle when the mirror angle is displaced downward in relation to gearshift operation means of the vehicle being put into a reverse position.

9. The vehicle mirror control device according to claim 5, wherein the target position is a target position of the mirror angle when the mirror angle is displaced downward in relation to gearshift operation means of the vehicle being put into a reverse position.

10. The vehicle mirror control device according to claim 2, wherein the target position is a mirror angle for driving the vehicle, the mirror angle being stored in advance in a mirror angle storage unit and read from the mirror angle storage unit via a predetermined reading instruction.

11. The vehicle mirror control device according to claim 3, wherein the target position is a mirror angle for driving the vehicle, the mirror angle being stored in advance in a mirror angle storage unit and read from the mirror angle storage unit via a predetermined reading instruction.

12. The vehicle mirror control device according to claim 4, wherein the target position is a mirror angle for driving the vehicle, the mirror angle being stored in advance in a mirror angle storage unit and read from the mirror angle storage unit via a predetermined reading instruction.

13. The vehicle mirror control device according to claim 5, wherein the target position is a mirror angle for driving the vehicle, the mirror angle being stored in advance in a mirror angle storage unit and read from the mirror angle storage unit via a predetermined reading instruction.
